(19) United States
(12) Patent Application Publication
(10) Pub. No.: US 2006/0107195 A1
(43) Pub. Date: May 18, 2006

(54) Methods and apparatus to present survey information

(76) Inventors: Arun Ramaswamy, Tampa, FL (US); Alan Bosworth, Odessa, FL (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/530,233

(22) PCT Filed: Oct. 2, 2003
(86) PCT No.: PCT/US03/31180

§ 371 Date: Sep. 6, 2005

Related U.S. Application Data
(60) Provisional application No. 60/415,615, filed on Oct. 2, 2002.

(51) Int. Cl. G06F 17/21; G06F 17/00

(52) U.S. Cl. 715/500.1; 715/730

(57) ABSTRACT

Methods and apparatus to present survey information are disclosed. In particular, the methods and apparatus present survey information based on media compositions and associated metadata information. The methods and apparatus are used to identify metadata associated with a media composition and generate a trigger compilation based on survey information and the metadata. A inband survey is generated by multiplexing the trigger compilation and the media composition.

### CROSS-REFERENCE TO RELATED APPLICATIONS

This application claims the benefit of U.S. Provisional Application No. 60/415,615, filed Oct. 2, 2002.

### FIELD OF THE DISCLOSURE

The present disclosure relates generally to information and processor systems and, more particularly, to methods and apparatus to present survey information.

### BACKGROUND

Surveys are often used to gather observer reactions and/or opinions about media content such as movies and/or advertisements or any content including, for example, video, audio, images, or any combination thereof. Traditionally, such surveys include a set of questions that are presented to observers at the end of a media presentation. For example, printed survey questions related to the media presentation may be distributed to an audience after the audience has viewed the media presentation. Alternatively, an audience member may access the survey questions via a computer that provides the questions in, for example, hypertext markup language (HTML) format in the form of a web page. For example, following a media presentation, the audience may be instructed to retrieve the survey questions associated with the media content using a specified uniform resource locator (URL).

Unfortunately, presenting survey questions to an audience member after the audience member has finished viewing or experiencing the media presentation may adversely affect the value of the answers to such survey questions. Specifically, an audience member responding to a set of survey questions about a media presentation must rely upon his recall of the media presentation when answering the questions. However, various factors may cause a respondent's recall to be inaccurate including, for example, the length of the media presentation and the location at which the subject of the survey question occurred within the media presentation. A scene occurring within the first five minutes of a movie is likely to be more difficult for the survey respondent to recall with accuracy than a scene occurring at the end of a two and a half hour movie. Likewise, due to the dependence on the respondent's recall, answers to questions about scenes occurring early in a movie are likely to less accurately reflect the respondent's attitude about the scene than answers to questions about scenes occurring later in a movie. Additionally, many surveyors are seeking a respondent's initial, emotional reaction to a particular piece of media. However, survey questions presented after a media presentation often cause the respondent to ponder the overall presentation and attempt to recall his/her initial reaction, thereby causing the respondent to provide a more reasoned answer to the survey questions instead of the more emotional reaction that was actually experienced at the time that the media was absorbed.

### BRIEF DESCRIPTION OF THE DRAWINGS

FIG. 1 is a block diagram of an example system that may be used to provide survey question presentations synchronously with associated media compositions.

FIG. 2 is a block diagram of an example processor system that may be used to implement the encoder and/or decoder of FIG. 1.

FIG. 3 is a functional block diagram of an example survey encoder, which may be used to implement the encoder of FIG. 1.

FIG. 4 is a functional block diagram of an example inband survey presentation generator.

FIG. 5 is a functional block diagram of an example external survey presentation generator.

FIG. 6 is a flow diagram of an example metadata processing method that may be used to analyze and process a media composition and associated metadata.

FIGS. 7a and 7b are flow diagrams of example survey generation processes that may be used to author/prepare a survey presentation.

FIG. 8 is an example trigger file representation of the trigger file generated in connection with FIGS. 5 and 7b.

FIG. 9 is a functional block diagram of an example survey decoder that may be used to implement the decoder of FIG. 1.

FIGS. 10-13b are flow diagrams of example decoding processes that may be used to decode and present media compositions and associated survey information.

FIG. 14 is example pseudo code that may be used to implement the matching method described in connection with FIG. 13b.

### DETAILED DESCRIPTION

Although the following discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware, or in any combination of hardware, firmware, and/or software. Accordingly, while the following describes example systems, persons of ordinary skill in the art will readily appreciate that the examples provided are not the only way to implement such systems.

The methods and apparatus described herein generally relate to survey presentations associated with a presentation of associated media content (i.e., video, audio, etc.). For example, the survey presentation and associated media content may be presented to an audience that may include a group of panelists/respondents or a single panelist/respondent. The survey presentation and the media content may be presented on a media presentation device such as, for example, a television, a video monitor, a cell phone, a personal digital assistant (PDA), or any type of handheld device. The media content may include a television commercial, a newscast presentation, a movie trailer, etc. and may be organized into several media segments, each including a portion, such as a scene or event, of the entire media content. For example, if the media content is a newscast presentation, the newscast presentation may be organized and presented as several smaller media segments, each corresponding to a different news story. The survey presentation, which may include survey questions, may be organized into several groups of survey questions, each of which may correspond to a segment of the media content (e.g., newscast presentation). Using this organization, a series of one or more triggers are inserted into the media presentation at one or more desired points in the presentation at which one or more of the survey questions will appear on screen or otherwise be provided to the survey respondent. The desired points may correspond, for example, to the points in the presentation located between the smaller media segments that correspond to a different news story, thereby allowing for a survey question to be posed immediately following a relevant portion of the media presentation. The trigger may also cause the media presentation to temporarily pause while the question(s) is being displayed.

In an example, a group of panelists may be gathered in a test room or screening area having a media presentation device such as a television, video monitor, etc. Additionally, the group of panelists may each be provided with response devices such as, for example, PDAs, cell phones, or any other type of handheld devices for use in responding to survey questions associated with a presentation of the media content. Following a presentation of a media segment, the inserted trigger is detected and the media presentation is temporarily paused while a group of survey questions are presented to the group of panelists. The survey questions may prompt the group of panelists to provide an opinion, using their response devices, based on the previously-viewed media segment. In this manner, the group of panelists may recall the previously-presented media segment with relative ease thereby improving the likelihood that the resulting answers accurately reflect the respondent's views.

Additionally or alternatively, by way of another example, the survey presentation may be presented to a single panelist/respondent in, for example, the panelist's home. Using a cable connection and/or an Internet connection, media content such as, for example, a video including a movie trailer could be downloaded and presented on a media presentation device such as, for example, a television, a video monitor, etc. A survey presentation including survey questions associated with the movie trailer could be downloaded and also presented on the media presentation device. Survey questions could be organized into groups of survey questions. A group of survey questions could be presented at a point during which the movie trailer is paused and may relate to the previously-viewed portion of the movie trailer. Another group of survey questions could be presented at another point during which the movie trailer is paused. The survey questions may prompt the panelist to enter a response using a response device such as, for example, a computer terminal, a remote control, or any type of handheld device. The responses could be transmitted over the cable connection and/or Internet connection to a central server. Alternatively, the responses could be stored locally on, for example, a memory coupled to the response device and retrieved at a later time. Further, the responses could be transmitted to a central server from the response device using, for example, a cellular network or other wireless communication.

A survey presentation may be presented in an adaptive manner so that the selection of the next survey question to be presented may be dependent on a response to a previous survey question. For example, if a response to a survey question indicates a dislike for the subject matter at question, the following survey questions may no longer be related to the disliked subject matter. In this manner, the survey questions may be presented using an adaptive presentation process. Additionally, a survey presentation may be a static survey presentation and/or a dynamic survey presentation. A static survey presentation may include static survey questions that were prepared or generated by a survey authoring device prior to a presentation of the media content. Alternatively, a survey presentation may be a dynamic survey presentation including dynamically authored survey questions that may be generated during a presentation of the media content.

In yet another example, the triggers causing the display of survey questions may be embodied as inaudible audio codes that are inserted into audio portions of the media presentation at times defined by the trigger definition or trigger information. The inaudible audio codes, when played by audio speakers associated with the media presentation device, are detected by a decoder and contain information that causes the decoder to display a survey question, for example. The inaudible audio codes may additionally be detected by a handheld response device used by a panelist to enter responses to the survey questions. The decoder disposed in the handheld response device may cause the handheld device to display the survey question and to display a set of answer choices associated with the survey question on a display screen associated with the handheld device. In response to the displayed question and possible choices, the respondent pushes a button or key associated with one of the possible choices. The handheld device may be adapted to transmit the entered data to a decoder disposed in or otherwise associated with the media presentation device for subsequent transmittal to a central data collection facility. Communication between a handheld response device and a decoder associated with the media presentation device may occur, for example, via radio frequency communication signals. Alternatively, the handheld device may be adapted to communicate directly with the central data collection facility via, for example, a wireless telephone network, provided, of course, that the handheld device includes wireless telephone communication capabilities.

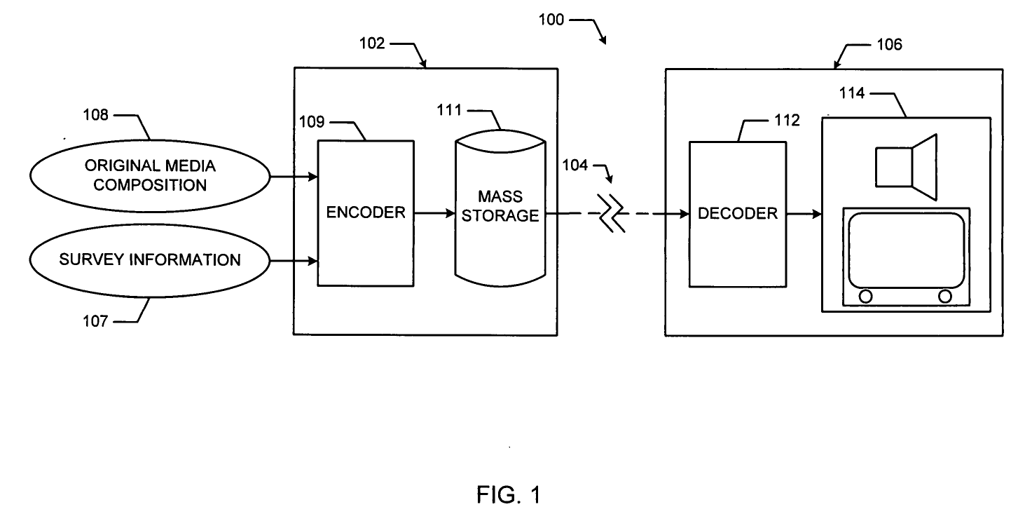

Turning now to FIG. 1, an example media network 100 that may be used to encode and decode survey presentations associated with media content includes an encoding subsystem 102 communicatively coupled via a communication interface 104 to a decoding subsystem 106. Additionally, a response device (not shown) (e.g., a computer terminal, a PDA, a remote control, or any other type of handheld device) may be communicatively coupled to the decoding subsystem 106 and may be used to provide responses associated with a survey presentation. Alternatively and/or additionally, the response device may be communicatively coupled to a central information system (i.e., central server) via, for example, a cellular network, a telephone network, or any other type of wired or wireless interface. The encoding subsystem 102 may be used to author and store a survey presentation. The survey presentation is authored or generated based on survey information 107 and media content that may include a media composition such as the original media composition 108. Additionally, the survey presentation includes at least portions of the survey information 107 and the original media composition 108 or a media composition associated with the original media composition 108 (e.g., a modified or processed version of the original media composition).

The communication interface 104 may be used to transfer the survey presentation from the encoding subsystem 102 to the decoding subsystem 106 and may include any suitable interface for transmitting data from one location to another. Furthermore, the communication interface 104 may include a wired (e.g., telephone network, Ethernet network, cable network, etc.) or wireless (e.g., cellular phone network, satellite network, 802.11 network, Bluetooth network, etc.) interface or any combination thereof.

The survey information 107 includes information that is related to the contents of a media composition such as, for example, the original media composition 108. In general, the survey information 107 may include survey questions, survey instructions, and/or information relating to, for example, the subject matter of the original media composition 108.

A media composition such as the original media composition 108 may include any type of media (i.e., audio, video, etc.) used to convey an idea or message associated with any area including, for example, education, advertisement, and/or entertainment. Additionally, a media composition may include audio media, video media, graphics media, textual media, still picture media, or any combinations thereof. Furthermore, it will be readily apparent to one skilled in the art that although, by way of example, the methods and apparatus described herein are described in terms of video media or audio media, the methods and apparatus may also be used to process other types of media (i.e., still pictures, graphics, textual, etc.).

With reference to further detail of FIG. 1, the encoding subsystem 102 includes an encoder 109 configured to author a survey presentation. In general, the encoder 109 analyzes and/or generates metadata associated with the original media composition 108. Further detail pertinent to the encoder, its operation, and its implementation is provided below.

As used herein, the term metadata refers to supplementary information describing specific instances of content in a media composition such as, for example, a creation date and time, a content ID of the media composition, creator information, blank frame information, decode information associated with watermarks, keyframe information, scene change information, and audio event information. For example, the metadata may include temporal and spatial information defining events such as blank frames, scene changes, or audio events in the media composition. In one example, the temporal information includes timestamps associated with specific times in the media composition at which events occur. Often, the timestamps include a start time and an end time that define the start and stop boundaries associated with an occurrence of an event. The spatial information includes location descriptions such as (x, y) locations on, for example, a video monitor on which an event appears. For example, if an event includes a blank frame, the (x, y) locations will define an entire video monitor screen. Alternatively, if an event includes closed captioning information, the (x, y) location description may define a location at the top or bottom portion of a video monitor screen. In addition to temporal and spatial information, the metadata may include a portion of the content to be displayed or presented such as, for example, closed-captioning text. Furthermore, a media composition may include several metadata entries or elements.

The encoder 109 also generates trigger information based on the metadata and the survey information 107. The trigger information includes trigger definitions that may be used as drivers or triggers to cause the presentation of portions of the survey information 107 at predefined times associated with a media presentation. For example, the trigger information may be generated based on temporal and/or spatial information described by the metadata that are used to generate trigger definitions, which define when and where selected portions of the survey information 107 are to be presented with respect to a media presentation. By way of further example, if a metadata entry or element includes a blank frame, a trigger definition may be generated to indicate that a selected portion of the survey information 107 is to be presented during the same time as the blank frame. In yet another example, the trigger definitions may be embodied as inaudible audio codes that are inserted into audio portions of the media presentation at a time or times defined by the trigger definitions or trigger information. The inaudible audio codes, when played by audio speakers associated with a presentation device 114, are detected by the decoder 112 and include information that causes the decoder 112 to display a survey question, for example. The inaudible audio codes may be generated by an audio code generator or encoder (not shown) that forms part of the encoder 109. Audio code generators/encoders are well known in the art and will not be discussed in greater detail. In this manner, a presentation of the survey information 107 may be synchronized with a media presentation based on the trigger information. The encoder 109 may store the generated survey presentation (which may include trigger information, a media composition and associated metadata, and the survey information 107) in a storage device, such as the mass storage device 111. The generated survey presentation stored in the mass storage device 111 may be read therefrom and transmitted or broadcast over the communication interface 104.

The decoding subsystem 106 may be configured to decode and present a survey presentation such as the survey presentation generated by the encoder 109 and stored in the mass storage device 111. As noted previously, the survey presentation includes the survey information 107, trigger information, a media composition, and associated metadata. In particular, the decoding subsystem 106 includes a decoder 112 that receives or retrieves the survey presentation from the mass storage device 111 via a communication interface 104. In general, during operation, the decoder 112 decodes the survey presentation and uses the trigger information to determine times and locations at which to cause various portions of the survey information 107 to be presented during presentation of an associated media composition. In this manner, temporal and spatial information stored in the trigger information may enable the decoder 112 to present the survey information 107 in a synchronous manner with a media composition on the presentation device 114. In an example in which survey information is presented based on inaudible audio codes, the trigger definitions or trigger information may specify the times during the media presentation in which the inaudible audio codes are presented or played. The inaudible audio codes, when played by audio speakers associated with the presentation device 114, may be detected by the decoder 112 and/or a response device and include information that causes the decoder 112 and/or the response device to display a survey question, for example. The inaudible audio codes may be detected by an inaudible audio detector (not shown) that forms part of the decoder 109 and/or the response device. Inaudible audio detectors are well known in the art and will not be discussed in greater detail. Further detail regarding implementational and operational aspects of the decoder 112 are provided below. The presentation device 114 may include any suitable presentation device or devices capable of communicating the media composition and survey information to an observer such as, for example, speakers, headphones, televisions, video monitors, etc.

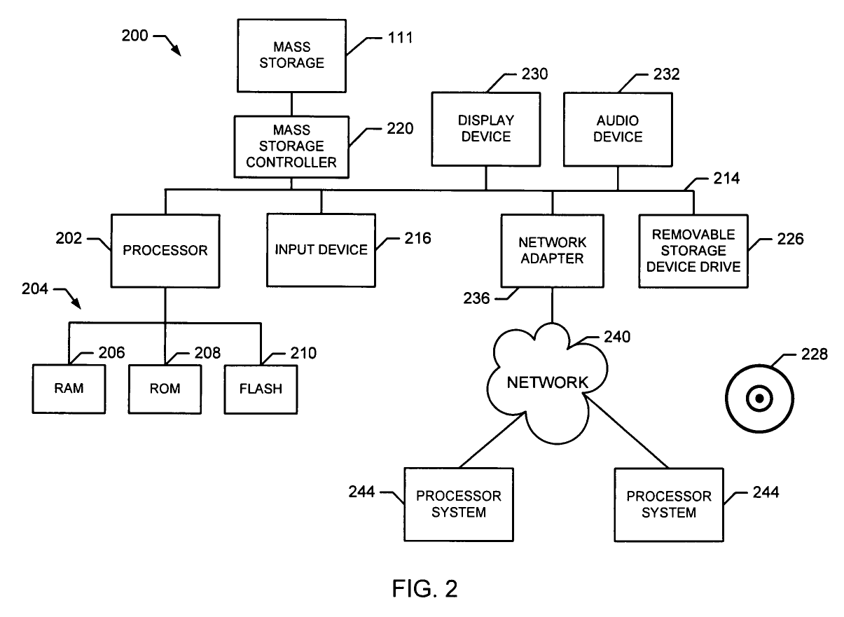

Turning now to FIG. 2, an example processor system 200, which, in general, may be used to implement the encoder 108 and/or the decoder 112 of FIG. 1, includes a processor 202 having associated system memory 204. The system memory 204 may include one or more of a random access memory (RAM) 206, a read only memory (ROM) 208, and a flash memory 210, or any other type of memory device.

The processor 202, in the example of FIG. 2, is coupled to an interface, such as a bus 214 to which other peripherals or devices are interfaced/coupled. In the illustrated example, the peripherals interfaced to the bus 214 include an input device 216, a mass storage controller 220 communicatively coupled to the mass storage device 111 of FIG. 1 (i.e., hard disk drive), and a removable storage device drive 226. The removable storage device drive 226 may include associated removable storage media 228, such as magnetic or optical media.

The example processor system 200 of FIG. 2 also includes a display device 230 and an audio device 232, both of which are peripherals coupled to the bus 214. The display device 230 may be used to present visual related media such as, for example, video, graphics, text, still pictures, etc. The audio device 232 may be used to present audio related media such as, for example, music, voice, etc. Additionally, the display device 230 and the audio device 232 may form part of the presentation device 114 of FIG. 1.

The example processor system 200 may be, for example, a conventional desktop personal computer, a notebook computer, a workstation or any other computing device. The processor 202 may be any type of processing unit, such as a microprocessor from Intel or any other processor manufacturer.

The memories 206, 208, and 210, which form some or all of the system memory 204, may be any suitable memory devices and may be sized to fit the storage demands of the system 200. The ROM 208, the flash memory 210, and the mass storage device 111 are non-volatile memories. Additionally, the mass storage device 111 may be, for example, any magnetic or optical media that is readable by the processor 202.

The input device 216 may be implemented using a keyboard, a mouse, a touch screen, a track pad, microphone, or any other device that enables a user to provide information to the processor 202. Further examples may include a cell phone, a personal digital assistant (PDA), a remote control, etc.

The removable storage device drive 226 may be, for example, an optical drive, such as a compact disk-recordable (CD-R) drive, a compact disk-rewritable (CD-RW) drive, a digital versatile disk (DVD) drive or any other optical drive. It may alternatively be, for example, a magnetic media drive. The removable storage media 228 is complimentary to the removable storage device drive 226, inasmuch as the media 228 is selected to operate with the drive 226. For example, if the removable storage device drive 226 is an optical drive, the removable storage media 128 may be a CD-R disk, a CD-RW disk, a DVD disk, or any other suitable optical disk. On the other hand, if the removable storage device drive 226 is a magnetic media device, the removable storage media 228 may be, for example, a diskette, or any other suitable magnetic storage media.

The display device 230 may be, for example, a liquid crystal display (LCD) monitor, a cathode ray tube (CRT) monitor, or any other suitable device that acts as an interface between the processor 202 and a user's or observer's visual sense. Furthermore, the display device 230 may be part of a conventional television.

The audio device 232 may be, for example, a sound adapter card interfaced with desktop speakers or audio headphones or any other suitable device that acts as an interface between the processor 202 and a user's or observer's aural sense. Furthermore, the audio device 232 may be used to drive the speakers of a conventional television. In other words, the display device 230 and the audio device 232 could be integrated together into a single unit, such as a conventional television.

The example processor system 200 also includes a network adapter 236, such as, for example, an Ethernet card or any other card that may be wired (e.g., telephone network, Ethernet network, cable network, etc.) or wireless (e.g., cellular phone network, satellite network, 802.11 network, Bluetooth network, etc.). The network adapter 236 provides network connectivity between the processor 202 and a network 240, which may be a local area network (LAN), a wide area network (WAN), the Internet, or any other suitable network. As shown in FIG. 2, further processor systems 244 may be coupled to the network 240, thereby providing for information exchange between the processor 202 and the processors of the processor systems 244.

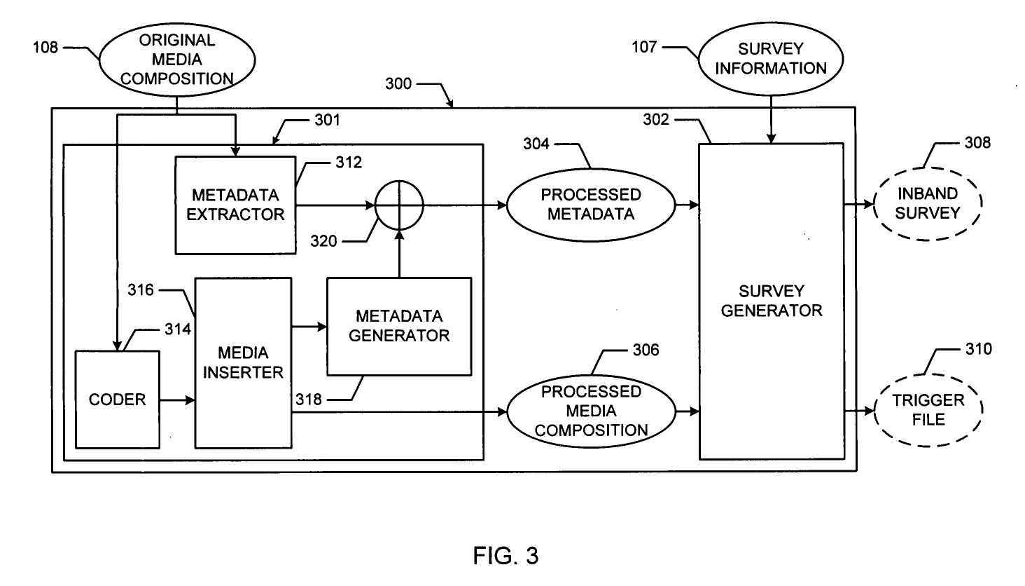

FIG. 3 is a functional block diagram of an example survey encoder 300, which may be used to implement the encoder 109 of FIG. 1. The example survey encoder 300 includes an example metadata processor 301 and an example survey generator 302. In general, the example metadata processor 301 may be used to generate processed metadata 304 and a processed media composition 306 based on the original media composition 108 and associated metadata.

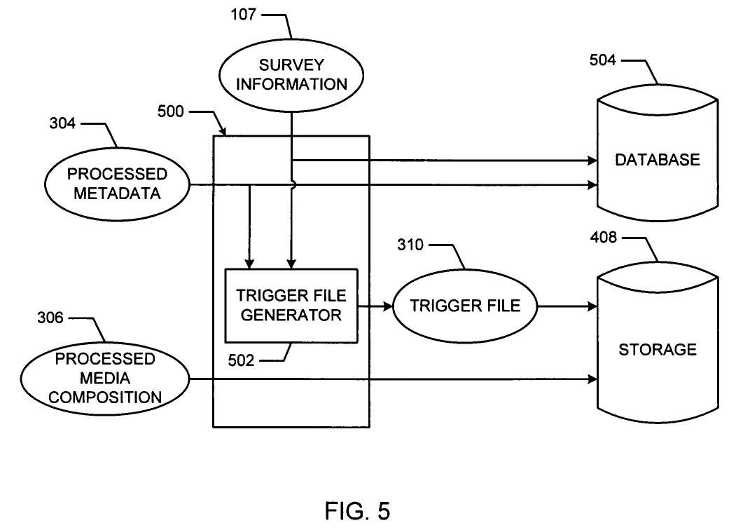

In operation, the survey generator 302 may be configured to receive or retrieve the survey information 107, the processed metadata 304, and the processed media composition 306 and to generate an inband survey presentation 308 or a trigger file 310 that forms part of a trigger file survey presentation (not shown). The inband survey presentation 308 is a multiplexed composition that includes the survey information 107, the processed metadata 304, the processed media composition 306 and trigger information. The trigger file 310, which as described in greater detail in connection with FIG. 5, forms part of a trigger file survey presentation. A trigger file survey presentation includes the trigger file 310, the survey information 107, the processed metadata 304, and the processed media composition 306, all of which may be stored separately from one another (e.g., each stored in a different storage area). Alternatively, the trigger file survey presentation may be generated as a multiplexed composition in which the trigger file 310, the survey information 107, the processed metadata 304, and the processed media composition 306 are multiplexed and stored as a single composition.

The trigger file 310 includes trigger information and may also include the survey information 107 or portions thereof. Alternatively, the trigger file 310 and the survey information 107 may be stored separately from one another. Additionally, the trigger file 310 may be generated as a text file or a programming language file such as, for example, extensible markup language (XML), HTML, C, and/or any other programming language.

As shown in further detail in FIG. 3, the metadata processor 301 includes a metadata extractor 312, a coder 314, a media inserter 316, a metadata generator 318, and a metadata merger 320. In general, during operation, the metadata processor 301 analyzes and processes the original media composition 108 to generate the processed metadata 304 and the processed media composition 306. The original media composition 108 may be a digital or analog media composition that may include original metadata describing content in the original media composition 108. The metadata extractor 312 receives or retrieves the original media composition 108 and demultiplexes or extracts the original metadata from the original media composition 108, then provides the original metadata to the metadata merger 320.

In particular, during operation of the metadata processor 301, the original media composition 108 may be encoded by the coder 314, which may be any type of media coder such as, for example, an analog-to-digital encoder, a moving pictures expert group (MPEG) encoder, an MP3 encoder, and/or any combination thereof. By way of example, if the original media composition 108 includes uncompressed digital video and uncompressed analog audio, the coder 314 may include an analog-to-digital encoder to encode the uncompressed analog audio to uncompressed digital audio, an MP3 encoder to compress the uncompressed digital audio, and an MPEG encoder to compress the uncompressed digital video. Accordingly, in the disclosed example, the output of the coder 314 may be compressed audio and video.

The metadata processor 301 may also be configured to insert additional information into the original media composition 108 using the media inserter 316. The media inserter 316 receives a processed original media composition (e.g., a compressed or digitized version of the original media composition 108) from the coder 314 and inserts additional information, thus generating a processed media composition 306. Additionally, the media inserter provides the additional information and/or the processed media composition 306 to the metadata generator 318. Additional information includes information that is not already part of the original media composition 108 such as, for example, composition title, closed captioning text, graphics, and watermarks. For example, inserting additional information may include inserting a watermark throughout the original media composition 108. Furthermore, the watermark may include digital information associated with digital rights management. The digital rights management information may include information relating to the origination and owners of the media composition content. Additionally or alternatively, the watermark may include a URL information associated with the location of supplemental information such as the survey information 107.

The metadata generator 318 may generate additional metadata for the additional information inserted by the media inserter 316. For example, if the additional information is a watermark, the additional metadata (e.g., watermark metadata), may include the creation date and time of the watermark and/or the identity of the watermark creator. The additional metadata may also include temporal and spatial information dictating when and where in the media composition the additional information is to be presented.

The original metadata, extracted by the metadata extractor 312, and the additional metadata, generated by the metadata generator 318, may be merged by the metadata merger 320, thus generating the processed metadata 304. In one example, the processed metadata 304 includes all of the metadata associated with the processed media composition 306 such as the original metadata and the additional metadata, both of which may be referred to as media composition metadata. Additionally, although not shown in FIG. 3, the processed metadata 304 may be merged into the processed media composition 306.

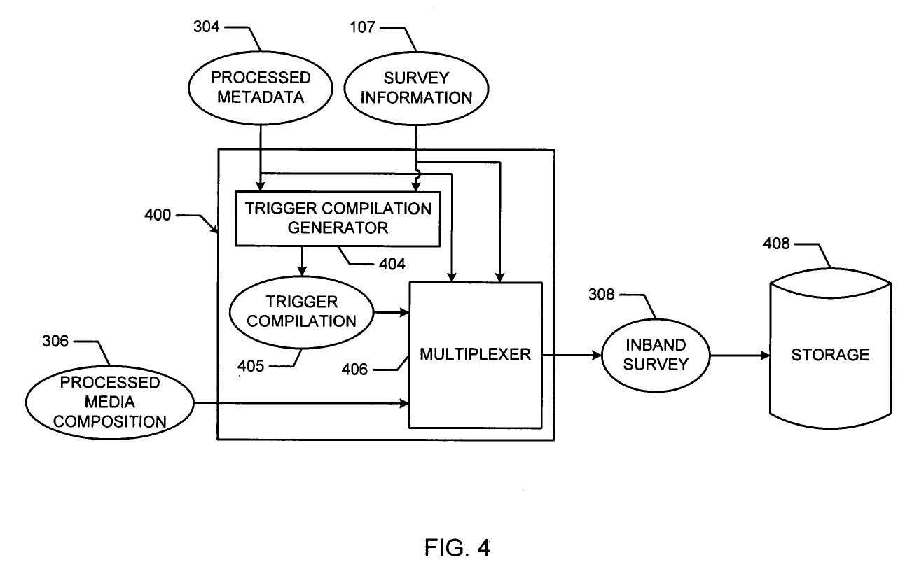

FIG. 4 is a functional block diagram of an example inband survey presentation generator 400. The example inband survey presentation generator 400 is an example implementation of the survey generator 302 of FIG. 3 that may be used to author the inband survey presentation 308. In general, the inband survey generator 400 receives the processed media composition 306 and the processed metadata 304 and combines the same with survey information 107 to generate the inband survey presentation 308. As shown in FIG. 4, in one example, the inband survey generator 400 includes a trigger compilation generator 404 that produces a trigger compilation 405, a multiplexer 406, and a storage area 408, all of which may be configured in combination to generate and store the inband survey presentation 308.

The trigger compilation generator 404, which generates the trigger compilation 405, extracts temporal and spatial information from the processed metadata 304 and uses the same to synchronize the survey information 107 with events (i.e., blank frames, scene changes, audio events, etc.) in the processed media composition 306.

The multiplexer 406 generates the inband survey presentation 308 by multiplexing the processed media composition 306, the processed metadata 304, the survey information 107, and the trigger compilation 405. The multiplexer 406 may multiplex data in an analog domain or in a digital domain. For example, if the processed media composition includes analog video content, the multiplexer 406 may insert or multiplex portions of the trigger compilation 405 and the survey information 107 into the vertical blanking intervals (VBI) of the analog video. Alternatively, if the processed media composition 306 includes digital audio and/or digital video, the multiplexer 406 may write portions of the trigger compilation 405 and the survey information 107 into data fields of the digital media such as an ID3 tag of an MP3 audio file or packet headers of an MPEG video file or any other type of data field associated with any other media encoding standard.

The inband survey presentation 308 may be generated once and stored in the storage area 408 for retrieval by decoders or players such as the decoder 112 of FIG. 1. The storage area 408 may be located on any suitable storage device capable of storing data for future retrieval such as the mass storage device 111 of FIG. 1 and/or the removable storage media 228 of FIG. 2. Additionally or alternatively, the storage area 408 may be implemented by a networked storage device that may be available via a network connection to a LAN, a WAN, or the Internet.

FIG. 5 is a functional block diagram of an example trigger file survey presentation generator 500. The example trigger file survey presentation generator 500 is another example implementation of the survey generator 302 of FIG. 3 that may be used to author a trigger file survey presentation. The trigger file survey generator 500 includes a trigger file generator 502 that may be configured to generate the trigger file 310 based on the survey information 107, the processed metadata 304, and the processed media composition 306. Additionally, the trigger file generator 502 may generate several trigger files associated with the survey information 107, the processed metadata 304, and the processed media composition 306. In this manner, a single trigger file survey presentation may include multiple trigger files.

In a trigger file survey presentation, the survey information 107, the processed metadata 304, the processed media composition 306, and the trigger file 310 may be multiplexed and stored as a single multiplexed composition in the storage area 408 or a database area 504. However, the trigger file survey presentation may also be generated by storing the survey information 107, the processed metadata 304, the processed media composition 306, and the trigger file 310 separately from one another in the storage area 408 and/or the database area 504. In particular, as shown in FIG. 5 by way of example, the processed media composition 306 and the trigger file 310 may be stored in the storage area 408, while the survey information 107 and the processed metadata 304 may be stored in the database area 504. The database area 504 may be located on the same storage device as the storage area 408 such as the mass storage device 111 or the removable storage media 228. Alternatively, the database area 504 may be located on a separate storage device similar to the mass storage device 111 and/or the removable storage media 228.

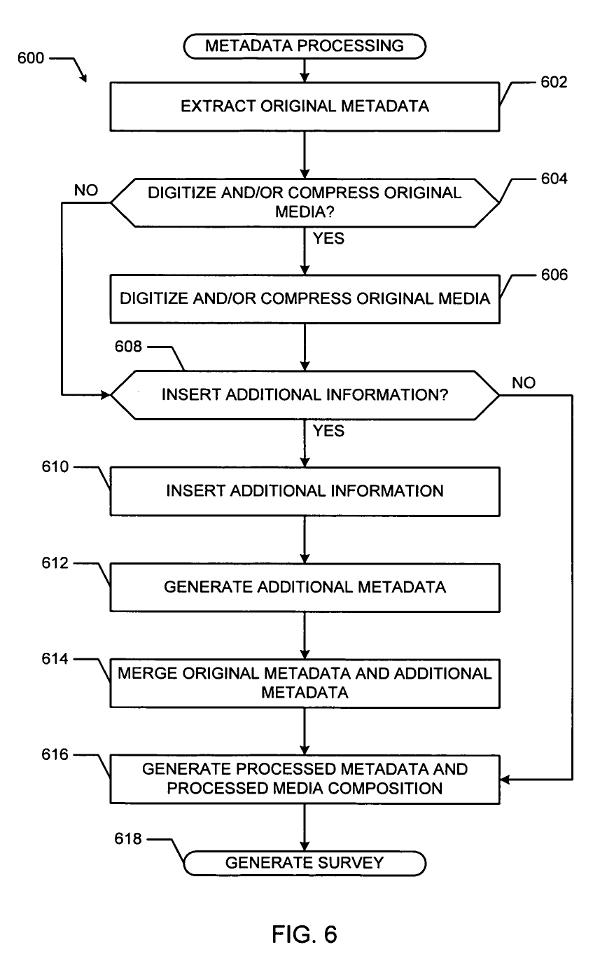

Now turning to FIG. 6, a flow diagram of an example media and metadata processing method 600, which may be used to analyze and process a media composition and associated metadata, may be implemented through software that is executed by a processor system such as the example processor system 200 of FIG. 2. In particular, the example media and metadata processing method 600 may be used to generate processed metadata and a processed media composition (i.e., the processed metadata 304 and the processed media composition 306 of FIG. 3) based on an original media composition (i.e., the original media composition 108 of FIG. 1).

According to the metadata processing method 600, any metadata that exists in the original media composition 108 is extracted as original metadata (block 602). If the original media composition 108 is to be digitized and/or compressed (block 604), it is digitized and/or compressed (block 606). In particular, if the original media composition 108 includes analog media, the original media composition 108 may be digitized using an analog-to-digital encoder. Additionally, digitized media may be compressed using, for example, audio compression techniques (i.e., MP3 encoding, AAC encoding, etc.), video compression techniques (i.e., MPEG, H.263, etc.), graphics and still picture compression techniques (i.e., JPEG, GIF, etc.), and/or any other media compression technique.

After the original media composition 108 is digitized and/or compressed (block 608) or if it is determined at block 604 that the original media composition 108 is not to be compressed and/or digitized, the metadata processing method 600 determines if additional information is to be inserted in the original media composition 108 (block 608). If additional information is to be added to the original media composition 108, then additional information is inserted (block 610). Additional information may include, for example, closed-captioning text and/or a watermark including a digital rights management information. Additional metadata is generated to describe the additional information inserted into the original media composition 108 (block 612). The additional metadata may include temporal and spatial information associated with when and where in the media composition the additional information is presented. Additionally, if the additional information is, for example, a watermark, the additional metadata may include the creation date and time, and information identifying the creator of the watermark.

After additional metadata is generated (block 612), the original metadata previously extracted (block 602) is merged with the additional metadata (block 614). After the original metadata and the additional metadata are merged (block 614) or if there is no need to insert additional information (block 608), the processed metadata 304 and the processed media composition 306 are generated (block 616). If additional information was inserted into the original media composition 108 (block 610), the processed metadata 304 includes the original metadata and the additional metadata generated at block 612. However, if additional information was not inserted, the processed metadata 304 includes the original metadata and may not include additional metadata. The processed media composition 306 may be a digitized and/or compressed version of the original media composition 108 and may include additional information (i.e., closed-captioning text, watermarks). Alternatively, if the original media composition 108 was not digitized and/or compressed (block 604) and if additional information was not inserted (block 610), the processed media composition 306 may include an unmodified version of the original media composition 108.

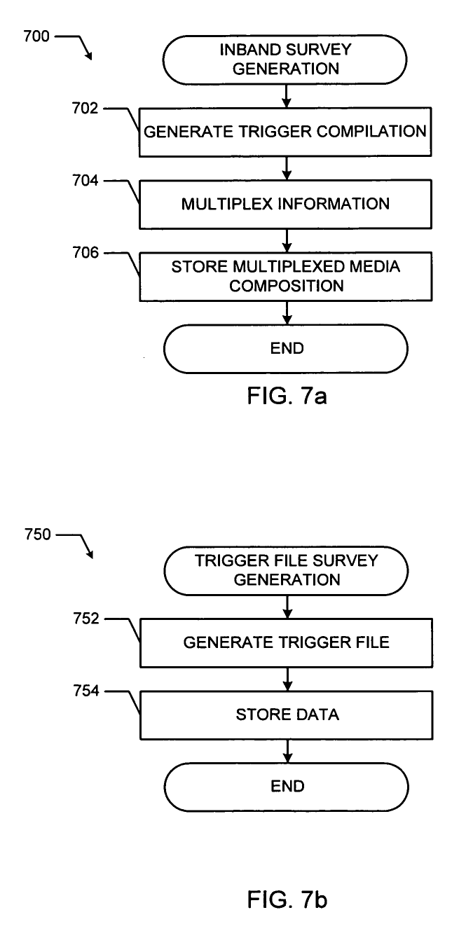

The processed metadata 304 and the processed media composition 306 may be used to generate a survey presentation (block 618). The survey presentation may be implemented as an inband survey presentation such as, for example, the inband survey presentation 308 described in greater detail in connection with FIG. 3, which may be generated using the methods described in connection with FIG. 7a. Alternatively, the survey presentation may be implemented as a trigger file survey presentation and may be generated using the methods described in connection with FIG. 7b.

FIGS. 7a and 7b are flow diagrams of example encoding methods that may be used to author a survey presentation. The example encoding methods may be implemented through software executed in a processor system such as, for example, the processor system 200 of FIG. 2. In particular, FIG. 7a is an example inband survey presentation generation method 700 that may be used to generate an inband survey presentation (i.e., the inband survey presentation 308 described in greater detail in connection with FIG. 3) and FIG. 7b is an example trigger file survey presentation generation method 750 that may be used to generate a trigger file survey presentation. In general, either of the example inband survey generation method 700 and the example trigger file survey generation method 750 may be used to implement the generate survey process at block 618 of FIG. 6.

Turning now in further detail to the inband survey generation method 700, the inband survey generation method 700 generates a trigger compilation (i.e., the trigger compilation 405 described in greater detail in connection with FIG. 4 above) (block 702) based on the processed metadata 304 and the survey information 107. The trigger compilation 405 may include temporal and spatial information relating to when and where in the media presentation the survey information 107 or portions thereof are to be presented. Additionally, the temporal and spatial information may describe events in the processed media composition 306 such as blank frames, scene changes, and audio events.

The trigger compilation 405, the survey information 107, the processed metadata 304, and the processed media composition 306 may be multiplexed (block 704) to generate the inband survey presentation 308. The inband survey presentation 308 may then be stored (block 706) in a data storage device such as, for example, the mass storage device 107 of FIG. 1 or the removable storage media 228 of FIG. 2.

As shown in FIG. 7b, the example trigger file survey generation method 750 may be used to generate a trigger file survey presentation. The trigger file survey generation method 750 generates a trigger file (i.e., the trigger file 310 described in greater detail in connection with FIG. 3 above) (block 752) based on the processed metadata 304 and the survey information 107.

The processed media composition 306, the trigger file 310, the survey information 107, and the processed metadata 304 are each stored in a storage area for future retrieval (block 754). The processed media composition 306, the trigger file 310, the survey information 107 and the processed metadata 304 may be generated as separate files or data entities; therefore each may be stored separately from one another. For example, the processed media composition 306 may be stored in a first storage device, the trigger file 310 may be stored in a second storage device, the survey information 107 may be stored in a third storage device, and the processed metadata 304 may be stored in a fourth storage device. Alternatively, as shown in FIG. 5 by way of example, the processed media composition 306 and the trigger file 310 may be stored in the storage area 408, while the survey information 107 and the processed metadata 304 may be stored in the database area 504. The storage area 408 may be located on a first storage device and the database area 504 may be located on a second storage device or they may both be located on the same storage device. The processed media composition 306 may include a watermark having information to indicate the storage locations of the trigger file 310, the survey information 107 and the processed metadata 304 so that a decoder (i.e., the decoder 112 of FIG. 1) may retrieve them.

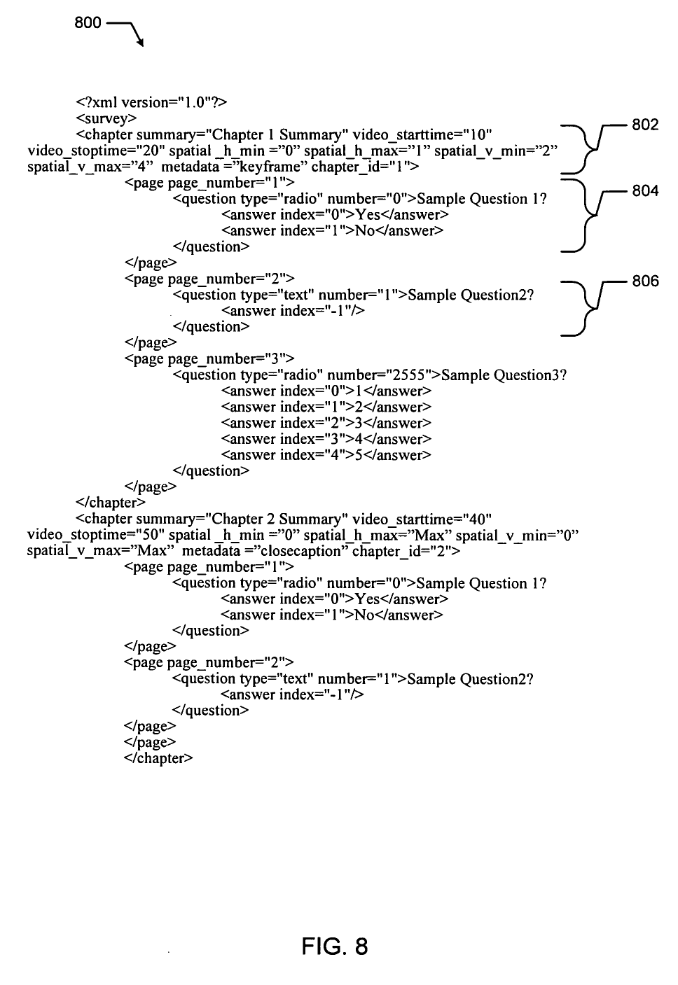

FIG. 8 is an example trigger file representation 800 of the trigger file 310 generated in connection with FIGS. 5 and 7b. More specifically, by way of example, the trigger file representation 800 includes XML language to implement trigger definitions. The trigger definitions may be used by the decoder 112 of FIG. 1 to present survey information including survey questions in combination with a media composition (i.e., the survey information 107 of FIG. 1 and the processed media composition 306 of FIG. 3). In particular, the trigger file representation 800 is associated with a video presentation and includes trigger information associated with the video presentation and the presentation of survey questions.

Chapter summary lines of code (LOC) 802 include information associated with a chapter summary, a video start time, a video stop time, a spatial horizontal minimum position, a spatial horizontal maximum position, a spatial vertical minimum position, a spatial vertical maximum, a metadata identifier and a chapter identifier. The chapter summary may include text describing the contents of a chapter associated with the survey questions. The video start and stop time parameters may be used to define a boundary of time during a presentation of the video within which the survey questions are to be presented. The spatial horizontal and vertical position parameters may be used to define physical coordinates on a video monitor where the survey questions are to be displayed. The metadata identifier shown in the trigger file code 800 indicates a keyframe, which defines the event in the video associated with the presentation of the survey questions. In other words, the survey questions are to be presented during a keyframe event in the video as defined by the start and stop times and the spatial positions. The chapter number may be used to identify the previously or currently viewed chapter with which the survey questions are associated.

Page one survey information LOC 804 include a question type parameter, a number parameter and answer indexes. The question type parameter indicates a radio question, which may be used to define a multiple choice question in which a user selects one answer from a list of several choices represented as radio buttons (i.e., multiple choice buttons) on the presentation device 114 of FIG. 1. The number parameter may be used to define a location identifier where the question may be found. For example, the number parameter indicates a “0”, which may define the zeroth entry in a database (i.e., the database 504 of FIG. 5). The answer indexes may be used to define the list of answers associated with the survey question.

Page two survey information LOC 806 also include a question type parameter, a number parameter and answer indexes. The question type parameter shown in the page two LOC 806 indicate a text question, which may define a survey question that asks for text input from a user such as a short answer or paragraph. The answer index parameter indicates a negative one, which may be used to indicate that there are no predetermined answer choices associated with this survey question.

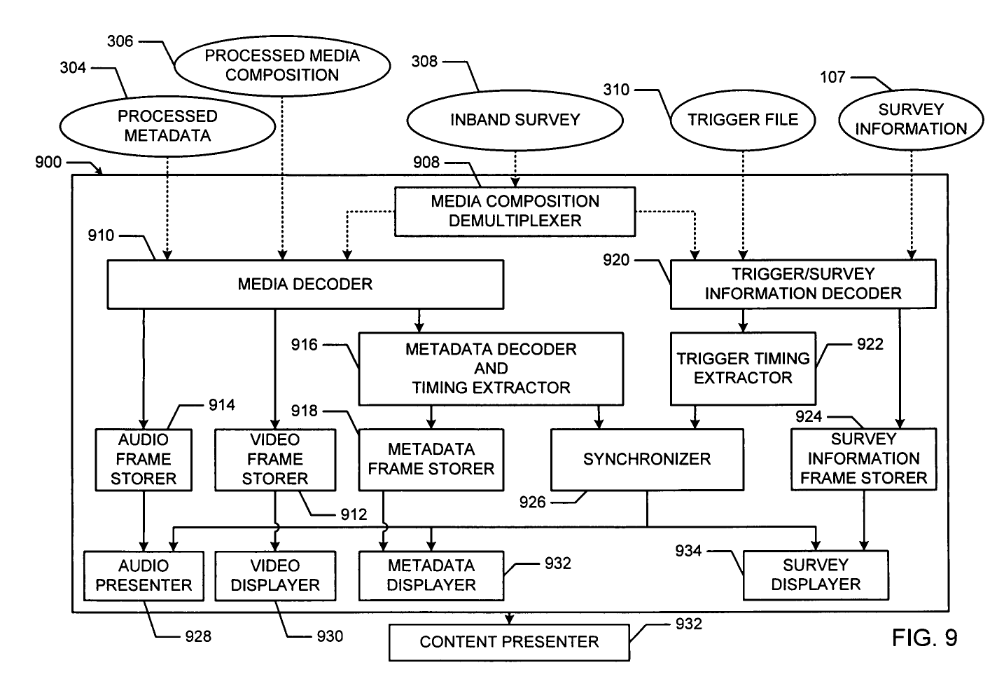

Having addressed various aspects of the encoder 109 of FIG. 1, attention is now turned to aspects of the decoder 112 of FIG. 1. FIG. 9 is a functional block diagram of an example survey decoder 900 that may be used to implement the decoder 112 of FIG. 1. In general, the example survey decoder 900 may be configured to decode survey presentations prepared or generated by the encoder 109 of FIG. 1. The survey presentations may include trigger information, survey information (i.e., the survey information 107 of FIG. 1), media compositions and associated metadata information (i.e., the processed media composition 306 and processed media metadata 304 of FIG. 3). Furthermore, the example survey decoder 900 may be configured to decode inband and/or trigger file survey presentations such as, for example, the inband survey presentation 308 authored in connection with FIGS. 4 and 7a and the trigger file survey presentation authored in connection with FIGS. 5 and 7b. The different configurations for an inband survey decoder and a trigger file survey decoder are shown by dotted lines and are described in greater detail below.

Now turning in detail to the example survey decoder 900 configured to decode the inband survey presentation 308, the example survey decoder 900 may retrieve or receive the inband survey presentation 308 from the mass storage device 111 shown in FIG. 1 via the communication interface 104. The inband survey presentation 308 is provided to the media composition demultiplexer 908, which may be configured to demultiplex the processed metadata 304, the processed media composition 306, the trigger compilation 405, and the survey information 107 from the inband survey presentation 308. The media composition demultiplexer 908 provides the processed media composition 306 to the media decoder 910. Additionally, the media composition demultiplexer 908 provides the trigger compilation 405 and the survey information 107 to the trigger/survey information decoder 920.

The processed media composition 306 is decoded by the media decoder 910 and provides decoded audio media to an audio frame storer 914, decoded video media to a video frame storer 912 and some or all of the decoded media to a metadata decoder and timing extractor 916. Also, the processed metadata 304 may be passed through the media decoder and provided to the metadata decoder and timing extractor 916. The media decoder 910 may include a single or multiple media decoders such as, for example, MPEG video decoders, MP3 audio decoders, and/or JPEG still picture decoders. In this manner, the media decoder 910 may be configured to decompress compressed media content. In instances where the processed media composition 306 includes video and/or still picture content, the video frame storer 912 may be configured to store frames of video decoded by the media decoder 910. In instances where the processed media composition 306 includes audio content the audio frame storer 914 may be configured to store frames of audio decoded by the media decoder 910.

The metadata decoder and timing extractor 916 receives or retrieves some or all of the decoded media and the processed metadata 304 from the media decoder 910. the metadata decoder and timing extractor 916 extracts or demultiplexes metadata that may be part of the decoded media and decodes the extracted or demultiplexed metadata and the processed metadata 304. Additionally, the metadata decoder and timing extractor 916 extracts a running time or timing ticks of the media content from the decoded media.

The processed metadata 304 may include information describing content of the processed media composition 306 such as, for example, composition title and chapter descriptions. Furthermore, the processed metadata 304 may also include presentable metadata such as closed-captioning text that may be presented or displayed with the decoded media. The presentable metadata is provided to and stored in the metadata frame storer 918. The media content of the decoded media includes running clock or timing ticks. The timing ticks are associated with the progress of the media decoding and/or the time position in the decoded media that is being provided by the media decoder 910. In particular, as the processed media composition 306 is being decoded by the media decoder 910, timing ticks are extracted from the decoded media by the metadata decoder and timing extractor 916 and provided to the synchronizer 926.

The trigger compilation 405 and the survey information 107 are received or retrieved and decoded by the trigger/survey information decoder 920. Temporal information is extracted from the trigger compilation by the trigger timing extractor 922. The temporal information includes trigger timing that may be used to define the time during a media composition presentation at which the survey information 107 or a portion thereof should be presented. In general, the survey information 107, which may include survey questions, is provided to and stored in the survey information frame storer 924 and the trigger timing is provided to the synchronizer 926. The survey information frame storer 924 stores portions of the survey information 107 to be presented or displayed according to the spatial information in the trigger compilation. For example, if the trigger compilation specifies a horizontal and vertical area on a video monitor screen, the survey information 107 may be stored in the survey information frame storer 924 according to the specified screen location definitions.

The timing ticks extracted by the metadata decoder and timing extractor 916 and the trigger timing extracted by the trigger timing extractor 922 are received or retrieved by the synchronizer 926 and used to synchronize the presentation of the audio, video and presentable metadata in addition to synchronizing the presentation of the associated survey information 107. The synchronizer 926 synchronizes the presentation of the audio, video and presentable metadata based on the timing ticks by respectively signaling the audio presenter 928, the video displayer 930, and the metadata displayer 932 to respectively present or display the next frame stored in the audio frame storer 914, video frame storer 912 and metadata frame storer 918.

The synchronizer 926 may also synchronize a presentation of the survey information 107 with the presentation of the audio, video and metadata. The trigger timing extracted by the trigger timing extractor 922 may be used by the synchronizer 926 to synchronize the survey information 107 with the presentation of the decoded media and presentable metadata. When the timing defined by the trigger timing matches the timing ticks extracted by the metadata and timing extractor 916, the synchronizer 926 synchronizes the presentation of the survey information 107 with the presentation of the audio, video and metadata by synchronously signaling the audio presenter 928, the video displayer 930, the metadata displayer 932 and the survey displayer 934 to respectively present or display the next frame stored in the audio frame storer 914, the video frame storer 912, the metadata frame storer 918 and the survey information frame storer 924. The synchronizer may also be configured to pause the presentation of the decoded media and the presentable metadata while the survey information is being displayed. For example, if the survey information 107 is to be displayed during a blank frame, the synchronizer 926 may pause the presentation of the audio, video and presentable metadata during the blank frame to present the survey information 107. In this manner, the duration of the blank frame may be varied as indicated by the trigger timing without having to encode multiple blank frames into the processed media composition 306.

The decoded media and the survey information 107 may be presented on a content presenter 932. In general, the content presenter 932 is similar to the presentation device 114 of FIG. 1 and may include any one or multiple devices for presenting audio, video and/or still pictures such as, for example, speakers, headphones, video monitors, televisions, PDAs, cell phones, or any other handheld or portable device. Responses to the survey information may be provided by an observer via the content presenter 932. Alternatively, an observer may use a response device (e.g., a computer terminal, a PDA, a remote control, or any other type of handheld device) that is communicatively coupled to the example survey decoder 900 and/or to a central information system/central data collection facility (i.e., a central server). Responses may be stored locally on, for example, a memory coupled to the response device and retrieved at a later time. Alternatively, the responses may be transmitted in real-time to the example survey decoder 900 and/or a central information system via, for example, wired (e.g., telephone network, Ethernet network, cable network, etc.) or wireless (e.g., cellular phone network, satellite network, 802.11 network, Bluetooth network, etc.) interface.

The example survey decoder 900 may also be configured to decode and present a trigger file survey presentation. In a trigger file survey presentation, the processed metadata 304 and the processed media composition 306 may be provided separately from the trigger file 310 and the survey information 107. Furthermore, the processed metadata 304, the processed media composition 306, the survey information 107 and the trigger file 310 may be received or retrieved independent of one another from the mass storage device 111 via the communication interface 104 of FIG. 1. The processed media composition 306 and the processed metadata 304 may be provided to the media decoder 910. The trigger file 310 and the survey information 107 may be provided to the trigger/survey information decoder 920. It would be readily apparent to one skilled in the art that the decode of the trigger file survey presentation and presentation processes thereof are similar to those described above in connection with the inband survey presentation.

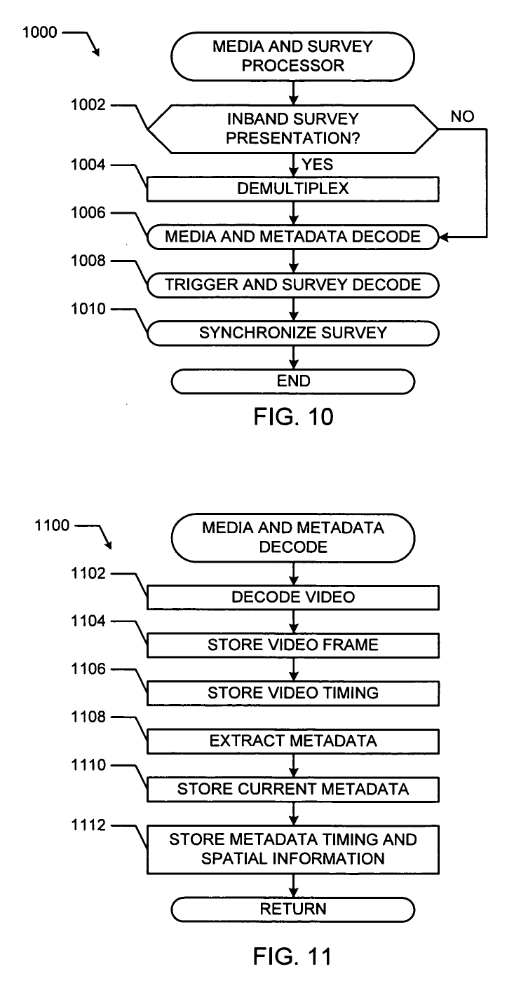

FIGS. 10-13b are flow diagrams of example decoding processes that may be used to decode and present survey presentations. The example decoding processes may be implemented by software executed by a processor system such as the processor system 200 of FIG. 2. In particular, the media and survey processor method 1000 may be used to decode survey presentations such as, for example, an inband survey presentation such as the inband survey presentation authored in connection with FIGS. 4 and 7a and a trigger file survey presentation such as the trigger file survey presentation authored in connection with FIGS. 5 and 7b. In particular, the media and survey processor method 1000 may be used to decode survey presentations by decoding, for example, the processed media composition 306 and the processed metadata 304 of FIG. 3, the survey information 107 of FIG. 1 and the trigger compilation 405 and trigger file 310 respectively generated in FIGS. 4 and 5.

If the survey presentation is an inband survey presentation such as the inband survey presentation 308 (block 1002), the inband survey presentation 308 is demultiplexed (block 1004) by separating the processed media composition 306, the processed metadata 304, the trigger compilation 405 and the survey information 107. After the inband survey presentation 308 is decoded or if the survey presentation is determined to be a trigger file survey presentation at block 1002, control is passed to block 1006. The processed media composition 306 and the processed metadata 304 are decoded (block 1006). For example, if the processed media composition 306 includes digital compressed video, it may be decoded by an MPEG video decoder. Additionally, the processed metadata 304 may include displayable text such as closed-captioning text or media events such as keyframes that may be decoded by a metadata decoder. The media and metadata decoding process (block 1006) are described in greater detail in connection with the media and metadata decode method 1100 of FIG. 11.

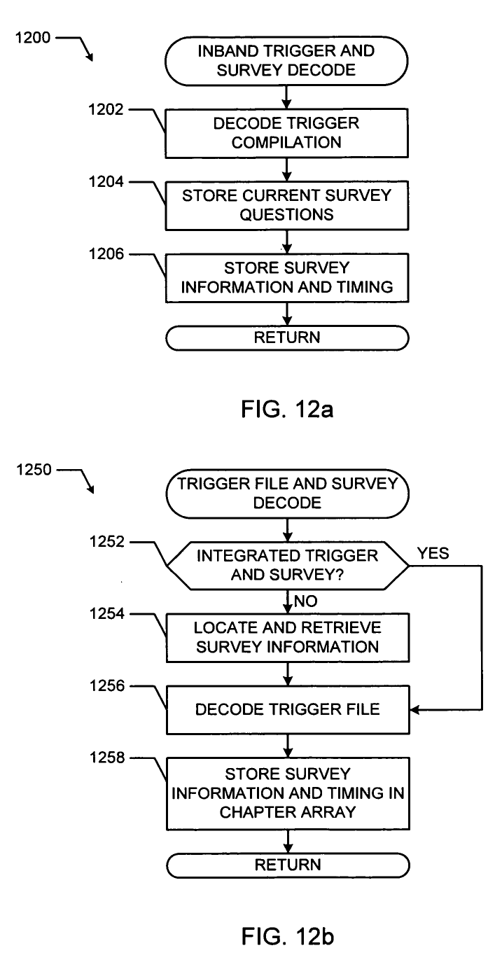

The trigger compilation 405 or the trigger file 310 and the survey information 107 are decoded by using the trigger and survey decode process (block 1008). The trigger and survey decode process (block 1008) may be implemented to decode the trigger compilation 405 and the survey information 107 that form part of the inband survey presentation 308 and/or the trigger file 310 and the survey information 107 that form part of a trigger file survey presentation. To decode the trigger compilation 405 and the survey information 107 associated with the inband survey presentation 308, the trigger and survey decode process (block 1008) may be implemented by the inband trigger and survey decode method 1200 of FIG. 12a. Alternatively, to decode the trigger file 310 and the survey information 107 associated with the trigger file survey presentation, the trigger and survey decode process may be implemented by the trigger file survey decode method 1250 of FIG. 12b.

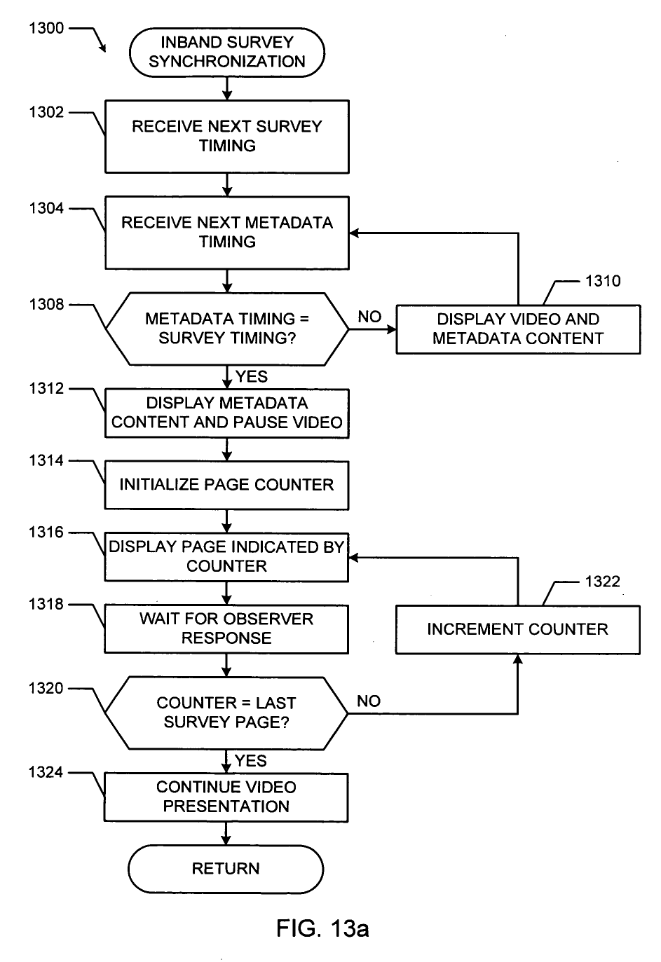

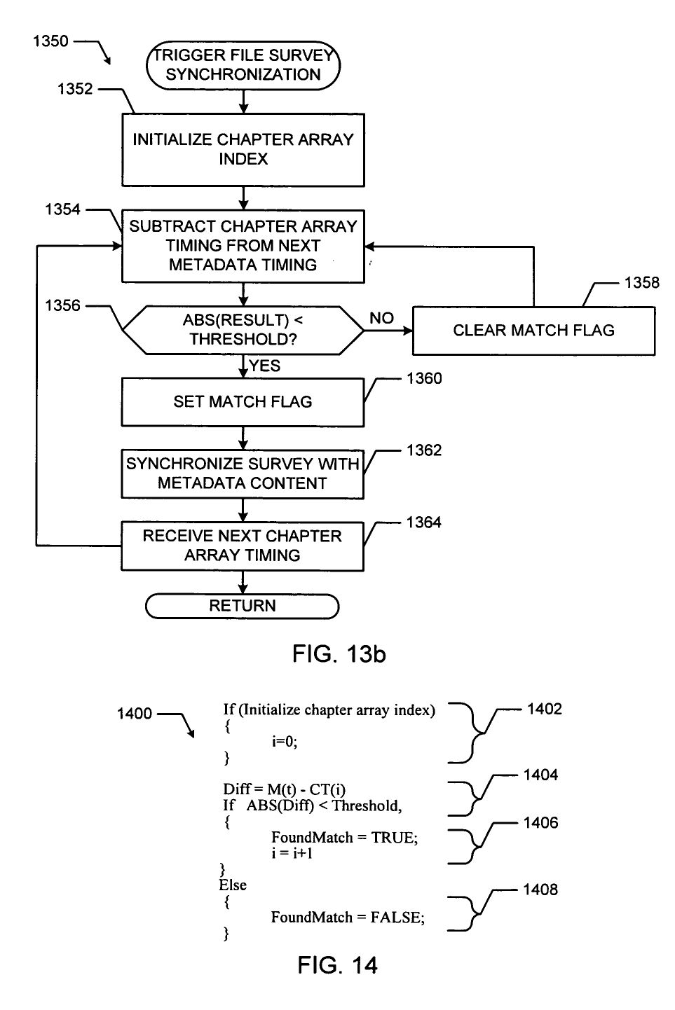

The processed media composition 306, the processed metadata 304 and the survey information 107 may be synchronized by the synchronize contents process (block 1010), which is described in greater detail in connection with the synchronize inband survey method 1300 of FIG. 13a and the synchronize trigger file survey method 1350 of FIG. 13b.

The processes described in connection with the media and metadata decode method 1100 of FIG. 11 may be used to decode a media composition and associated metadata such as, for example, the processed media composition 306 and the processed metadata 304. Although, the processes described in connection with the media and metadata decode method 1100 may be used to decode any type of media including audio, video and still pictures, the description of the media and metadata decode method 1100 will be based on a video composition.

The video composition may be stored and delivered in one of several formats including digitized, compressed and non-compressed formats. The video is decoded (block 1102) from its storage and/or delivery format to a presentable format. For example, if the video is digitized and compressed using an MPEG compression standard, an MPEG decoder may be used to decompress and reconstruct each frame of the digitized video composition. Each video frame is stored (block 1104) in a memory and may be retrieved in a sequential manner during a presentation of the video composition. Additionally, the video composition includes timing ticks (i.e., video timing) that track a current time position of the decoded video composition. The video timing is stored (block 1106) in a memory and may be used to reference the point in the video that is being decoded or presented. Any metadata in the video composition, which may include the processed metadata 304 is extracted (block 1108). As the video composition is being decoded (block 1102), the metadata associated with the decoded video is stored (block 1110). Additionally, the timing and spatial information associated with the metadata is stored (block 1112).

The inband trigger and survey decode method 1200 of FIG. 12a may be used to implement the trigger and survey decode process (block 1008) of FIG. 10 for an inband survey presentation such as the survey presentation 308 described in connection with FIG. 3 above. In particular, the inband trigger and survey decode method 1200 may be used to decode a trigger compilation and survey information (i.e., the trigger compilation 405 of FIG. 4 and the survey information 107 of FIG. 1) associated with the inband survey presentation 308. The trigger compilation 405 is decoded (block 1202), which may include extracting the survey information 107 from the trigger compilation 405 or using location information in the trigger compilation 405 to retrieve the survey information 107. For example, the trigger compilation 405 may include a URL that may be used to retrieve the survey information 107 from an Internet server. The survey information 107 may include survey questions that are stored in a memory (block 1204) for future retrieval and presentation. Additionally, the trigger compilation 405 includes temporal and spatial information associated with the presentation and placement of portions of the survey information 107 during a media composition presentation. In particular, the temporal information includes survey timing that defines a time associated with the timing ticks of a decoded media composition. The survey timing defines the points during the presentation of a media composition at which the survey information 107 or a portion thereof will be presented. The survey information 107 and associated timing are stored (block 1206) and may be used to present the survey information 107 in a synchronous manner with a media composition such as the video composition described in connection with FIG. 11.

The trigger file and survey decode method 1250 of FIG. 12b may be used to implement the trigger and survey decode process (block 1008) of FIG. 10 for a trigger file survey presentation. In particular, the trigger file and survey decode method 1250 may be used to decode a trigger file and survey information (i.e., the trigger file 310 of FIG. 3 and the survey information 107 of FIG. 1) associated with a trigger file survey presentation. The trigger file 310 may have a plurality of trigger entries N for synchronizing a plurality of survey questions included in the survey information 107. If the survey information 107 is located or stored separately from the trigger file 310, the survey information 107 is located and retrieved (block 1254). The trigger file 310 may include information that includes the location of the survey information 107 such as a URL, in which case the URL is used to locate and retrieve the survey information 107 (block 1254).

After the survey information 107 is located or if it was determined at block 1252 that the survey information 107 is integrally stored or located with the trigger file 310, control is passed to block 1256. The trigger file 310 is decoded (block 1256), which may include extracting temporal and spatial information associated with the presentation of the survey information 107. In particular, the temporal information includes survey timing that defines the points during a presentation of a media composition at which the survey information 107 or a portion thereof will be presented. The survey information 107 and associated timing information are stored in a chapter array (i.e., C(0), C(1), . . . , C(N−1), where N is the number of trigger entries as described above) and a chapter timing array (i.e., CT(0), . . . , CT(N−1)) and may be used to present the survey information 107 in synchronization with a presentation of a media composition such as the video composition described in connection with FIG. 11.

FIG. 13a is a flow diagram of an inband survey synchronization method 1300 that may be used to implement the synchronize contents process (block 1010) of FIG. 10 for synchronizing an inband survey presentation such as the inband survey presentation 308 described in connection with FIG. 3. In particular, the inband survey synchronization method 1300 may be used to synchronize survey information and a media composition (i.e., the survey information 107 of FIG. 1 and the processed media composition 306 of FIG. 3) associated with the inband survey presentation 308. More specifically, the media composition described in connection with the processes of the inband survey synchronization method 1300 is a video composition. During the presentation of the video composition, the next survey timing is received (block 1108). The next survey timing defines the point during the video composition presentation at which the next portion of the survey information 107 is to be presented. The next metadata timing or timestamp is received (block 1304) and is compared to the survey timing (block 1308). If the metadata timing or timestamp is not equal to the survey timing (block 1308), the current video frame and content described by the metadata (i.e., title text, chapter text, blank frame) are displayed (block 1310) and the next metadata timing or timestamp is received (block 1304). If the metadata timing or timestamp is equal to the survey timing (block 1308), the content described by the metadata is displayed and the video is paused (block 1312). The content described by the metadata may be the end of a chapter indicated by a blank screen that enhances readability of a survey presentation. Additionally, because the video may be paused for an indefinite length of time, pausing the video enables the survey information 107 or a portion thereof to be presented for any desired length of time (i.e., without time limits).

A page counter is initialized (block 1314) to track the number of survey pages that have been displayed. The survey page indicated by the page counter is displayed (block 1304) and includes at least a portion of the survey information 107. The portion of the survey information 107 displayed on the survey page (block 304) may be associated with the portion of the video composition that was presented immediately prior to displaying the survey page. Furthermore, the survey page may include survey questions asking an observer to provide an answer with respect to the portion of video. A period of time elapses during which the observer is given time to respond to a question (block 1306). The observer may respond using for example a response device (e.g., a computer terminal, a PDA, a remote control, or any other type of handheld device). The response may be stored locally on, for example, a memory coupled to the response device and transmitted at a later time to a central server or a decoder (i.e., the decoder 112 of FIG. 1). Alternatively, the responses may be transmitted to a central information system (i.e., a central server) or the decoder 112 in real-time using, for example, a wired (e.g., telephone network, Ethernet network, cable network, etc.) or wireless (e.g., cellular phone network, satellite network, 802.11 network, Bluetooth network, etc.) interface.

Once the observer responds, if the page counter is not equal to the last survey page, the counter is incremented (block 1322) and control is passed back to block 1304 to display the next survey page. The next survey page may be configured to follow sequentially from the previous survey page. In an alternate configuration, which may include an adaptive presentation process, the selection of the next survey page to be presented may be based on the response(s) associated with the previous survey page. For example, trigger definitions of the trigger file 310 or the trigger compilation 405 may include conditional criteria that defines which survey page to display next based on the response(s) associated with the previous survey page.

On the other hand, once the observer responds, if the page counter is equal to the last survey page such as the last survey page in a chapter (block 1320), the video presentation is unpaused and continues (block 1324).

FIG. 13b is a flow diagram of a matching method 1350 used to implement the synchronize contents process (block 1010) of FIG. 10 for synchronizing a trigger file survey presentation. In particular, the matching method 1350 may be used to synchronize survey information and a media composition (i.e., the survey information 107 of FIG. 1 and the processed media composition 306 of FIG. 3) associated with a trigger file survey presentation. More specifically, the media composition described in association with the processes of the matching method 1350 is a video composition that is divided into several chapters. Each chapter is associated with a portion of the survey information 107. A chapter array index i is initialized (block 1352) to track and retrieve the portion of the survey information 107 associated with a chapter designated by the chapter array index i. Furthermore, the chapter array index i is used to index the chapter array C(i) and chapter timing array CT(i) described in greater detail in connection with FIG. 12b above.

The time defined by the chapter timing array CT(i) is subtracted from the time designated by a next metadata timing parameter M(t) (i.e., a timestamp) (block 1354). The metadata timing parameter M(t) represents the timing information described by the next metadata. For example, the next metadata may describe a blank screen and include a metadata timing parameter M(t) that provides timing information or a timestamp indicating when the blank screen is to be presented. If the absolute value of the difference between the times defined by the chapter timing array CT(i) and the metadata timing parameter M(t) is not less than a time threshold value (block 1356), a match flag is cleared (block 1358) indicating that a timing match has not been met. The time threshold value may be defined as an amount of time that will enable survey information associated with the chapter array index C(i) to be displayed with the content described by the next metadata.

If the absolute value of the difference between the times defined by the chapter timing array CT(i) and the metadata timing parameter M(t) is less than the time threshold (block 1356), the match flag is set (block 1360). At least a portion of the survey information 107 defined by the chapter array C(i) is displayed with the content described by the metadata (block 1362). Additionally, the video may be paused during this time. The next chapter array timing CT(i+1) is then retrieved and control is passed back to block 1354.

FIG. 14 is example pseudo code 1400 that may be used to implement the matching method 1350 described in connection with FIG. 13b. If the chapter array index requires initialization, it is set to zero 1110. The absolute difference between the timings defined by the chapter array timing CT(i) and the next metadata timing M(t) is compared to the timing threshold value 1404. If the absolute difference is less than the timing threshold value, the match flag is set and the chapter array index i is incremented to retrieve the next chapter array timing CT(i+1) 1406. Otherwise, if the absolute difference is greater than the timing threshold, the match flag is cleared 1408.

Although certain methods, apparatus and articles of manufacture have been described herein, the scope of coverage of this patent is not limited thereto. To the contrary, this patent covers all methods, apparatus and articles of manufacture fairly falling within the scope of the appended claims either literally or under the doctrine of equivalents.

What is claimed is:

1. A method comprising:
generating trigger information based on metadata associated with a media composition; and
synchronizing a presentation of survey information with a presentation of the media composition based on the trigger information.

2. A method as defined in claim 1, wherein the survey information includes at least one survey question.

3. A method as defined in claim 1, wherein the survey information is associated with a subject matter of the media composition.

4. A method as defined in claim 1, wherein generating the trigger information comprises extracting temporal and spatial information from the metadata.

5. A method as defined in claim 1, wherein the media composition includes at least one of audio media, video media, and still picture media.

6. A method as defined in claim 1, wherein synchronizing the survey information comprises synchronizing at least a portion of the survey information with a blank frame associated with the media composition.

7. A method as defined in claim 1, wherein synchronizing the survey information comprises synchronizing at least a portion of the survey information with a time position of the media composition located between the end of the media composition and the beginning of the media composition.

8. A method as defined in claim 1, wherein the trigger information forms part of a trigger file.

9. An apparatus comprising:
a processor system including a memory;
instructions stored in the memory that enable the processor system to:
generate trigger information based on metadata associated with a media composition; and
synchronize a presentation of survey information with a presentation of the media composition based on the trigger information.

10. An apparatus as defined in claim 9, wherein the survey information includes at least one survey question.

11. An apparatus as defined in claim 9, wherein the survey information is associated with a subject matter of the media composition.

12. An apparatus as defined in claim 9, wherein instructions stored in the memory enable the processor system to extract temporal and spatial information from the metadata.

13. An apparatus as defined in claim 12, wherein instructions stored in the memory enable the processor system to generate the trigger information based on the temporal and spatial information.

14. An apparatus as defined in claim 9, wherein the media composition includes at least one of audio media, video media, and still picture media.

15. An apparatus as defined in claim 9, wherein instructions stored in the memory enable the processor system to synchronize at least a portion of the survey information with a blank frame associated with the media composition.

16. An apparatus as defined in claim 9, wherein instructions stored in the memory enable the processor system to synchronize at least a portion of the survey information with a time position of the media composition located between the end of the media composition and the beginning of the media composition.

17. An apparatus as defined in claim 9, wherein the trigger information forms part of a trigger file.

18. A computer readable medium having instructions stored thereon that, when executed, cause a machine to:
generate trigger information based on metadata associated with a media composition; and
synchronize a presentation of survey information with a presentation of the media composition based on the trigger information.

19. A computer readable medium as defined in claim 18 having instructions stored thereon that, when executed, cause the machine to extract at least one survey question from the survey information.

20. A computer readable medium as defined in claim 18 having instructions stored thereon that, when executed, cause the machine to extract temporal and spatial information from the metadata.

21. A computer readable medium as defined in claim 20 having instructions stored thereon that, when executed, cause the machine to generate the trigger information based on the temporal and spatial information.

22. A computer readable medium as defined in claim 18 having instructions stored thereon that, when executed, cause the machine to decode at least one of audio media, video media, and still picture media associated with the media composition.

23. A computer readable medium as defined in claim 18 having instructions stored thereon that, when executed, cause the machine to synchronize at least a portion of the survey information with a blank frame associated with the media composition.

24. A computer readable medium as defined in claim 18 having instructions stored thereon that, when executed, cause the machine to synchronize at least a portion of the survey information with a time position of the media composition located between the end of the media composition and the beginning of the media composition.

25. A computer readable medium as defined in claim 18 having instructions stored thereon that, when executed, cause the machine to extract the trigger information from a trigger file.

26. A method comprising:
extracting survey presentation information from trigger information associated with a media composition; and
synchronizing a presentation of survey information with a presentation of the media composition based on the survey presentation information.

27. A method as defined in claim 26, wherein the survey presentation information includes temporal and spatial information associated with a presentation of the media composition.

28. A method as defined in claim 26, wherein the presentation of the survey information comprises synchronizing at least a portion of the survey information with a presentation of a blank frame associated with the presentation of the media composition.

29. A method as defined in claim 26, wherein the presentation of the survey information comprises presenting at least a portion of the survey information during the presentation of the media composition at a time between the beginning of the presentation of the media composition and the end of the presentation of the media composition.

30. A method as defined in claim 26, wherein the survey information includes at least one survey question.

31. An apparatus comprising:
a processor system including a memory;
instructions stored in the memory that enable the processor system to:
extract survey presentation information from trigger information associated with a media composition; and
synchronize a presentation of survey information with a presentation of the media composition based on the survey presentation information.

32. An apparatus as defined in claim 31, wherein the survey presentation information includes temporal and spatial information associated with a presentation of the media composition.

33. An apparatus as defined in claim 31, wherein the instructions stored in the memory enable the processor system to synchronize at least a portion of the survey information with a presentation of a blank frame associated with the presentation of the media composition.

34. An apparatus as defined in claim 31, wherein the instructions stored in the memory enable the processor system to present at least a portion of the survey information during the presentation of the media composition at a time between the beginning of the presentation of the media composition and the end of the presentation of the media composition.

35. An apparatus as defined in claim 31, wherein the survey information includes at least one survey question.

36. A computer readable medium having instructions stored thereon that, when executed, cause a machine to:
extract survey presentation information from trigger information associated with a media composition; and
synchronize a presentation of survey information with a presentation of the media composition based on the survey presentation information.

37. A computer readable medium as defined in claim 36 having instructions stored thereon that, when executed, cause the machine to extract temporal and spatial information associated with a presentation of the media composition from the survey presentation information.

38. A computer readable medium as defined in claim 36 having instructions stored thereon that, when executed, cause the machine to synchronize at least a portion of the survey information with a presentation of a blank frame associated with the presentation of the media composition.

39. A computer readable medium as defined in claim 36 having instructions stored thereon that, when executed, cause the machine to present at least a portion of the survey information during the presentation of the media composition at a time between the beginning of the presentation of the media composition and the end of the presentation of the media composition.

40. A computer readable medium as defined in claim 36 having instructions stored thereon that, when executed, cause the machine to extract at least one survey question from the survey information.

41. A method comprising:
identifying media composition metadata associated with a media composition;
generating a trigger compilation based on survey information and the media composition metadata; and
generating an inband survey by multiplexing the trigger compilation and the media composition.

42. A method as defined in claim 41, wherein identifying the media composition metadata comprises at least one of generating the media composition metadata based on the media composition and extracting the media composition metadata from the media composition.

43. A method as defined in claim 41, further comprising compressing at least a portion of the inband survey.

44. A method as defined in claim 41, further comprising inserting at least one watermark into the media composition.

45. A method as defined in claim 44, wherein inserting the at least one watermark into the media composition comprises generating watermark metadata associated with the at least one watermark.

46. A method as defined in claim 41, wherein generating the trigger compilation comprises detecting at least one of a blank frame, a scene change event and, an audio event in the media composition.

47. A method as defined in claim 46, wherein detecting the at least one of a blank frame, a scene change event and an audio event comprises determining temporal information and spatial information associated with the at least one of a blank frame, a scene change event, and an audio event.

48. A method as defined in claim 41, wherein generating the inband survey comprises inserting at least a portion of the trigger compilation into at least one vertical blanking interval of the media composition.

49. A method as defined in claim 41, wherein generating the inband survey comprises inserting at least a portion of the trigger compilation into at least one data field associated with the inband survey.

50. An apparatus comprising:
a processor system including a memory;
instructions stored in the memory that enable the processor system to:
identify media composition metadata associated with a media composition;
generate a trigger compilation based on survey information and the media composition metadata; and
generate an inband survey by multiplexing the trigger compilation and the media composition.

51. An apparatus as defined in claim 50, wherein the instructions stored in the memory enable the processor system to identify the media composition metadata based on at least one of generating the media composition metadata based on the media composition and extracting the media composition metadata from the media composition.

52. An apparatus as defined in claim 50, wherein the instructions stored in the memory enable the processor system to compress at least a portion of the inband survey.

53. An apparatus as defined in claim 50, wherein the instructions stored in the memory enable the processor system to insert at least one watermark into the media composition.

54. An apparatus as defined in claim 53, wherein the at least one watermark is associated with digital rights management.

55. An apparatus as defined in claim 53, wherein the instructions stored in the memory enable the processor system to generate watermark metadata associated with the at least one watermark.

56. An apparatus as defined in claim 50, wherein the instructions stored in the memory enable the processor system to detect at least one of a blank frame, a scene change event, and an audio event associated with the media composition.

57. An apparatus as defined in claim 56, wherein the instructions stored in the memory enable the processor system to determine temporal information and spatial information associated with the at least one of a blank frame, a scene change event, and an audio event.

58. An apparatus as defined in claim 50, wherein the instructions stored in the memory enable the processor system to insert at least a portion of the trigger compilation into at least one vertical blanking interval of the media composition.

59. An apparatus as defined in claim 50, wherein the instructions stored in the memory enable the processor system to insert at least a portion of the trigger compilation into at least one data field associated with the inband survey.

60. An apparatus as defined in claim 50, wherein the survey information includes survey questions associated with the media composition.

61. An apparatus as defined in claim 50, wherein the trigger compilation includes temporal information and spatial information associated with the survey information.

62. An apparatus as defined in claim 50, wherein the media composition includes at least one of video media, audio media, graphics media, textual media, and still picture media.

63. A computer readable medium having instructions stored thereon that, when executed, cause a machine to:
identify media composition metadata associated with a media composition;
generate a trigger compilation based on survey information and the media composition metadata; and
generate an inband survey by multiplexing the trigger compilation and the media composition.

64. A computer readable medium as defined in claim 63 having instructions stored thereon that, when executed, cause the machine to identify the media composition metadata based on at least one of generating the media composition metadata based on the media composition and extracting the media composition metadata from the media composition.

65. A computer readable medium as defined in claim 63 having instructions stored thereon that, when executed, cause the machine to compress at least a portion of the inband survey.

66. A computer readable medium as defined in claim 63 having instructions stored thereon that, when executed, cause the machine to insert at least one watermark into the media composition.

67. A computer readable medium as defined in claim 66 having instructions stored thereon that, when executed, cause the machine to generate watermark metadata associated with the at least one watermark.

68. A computer readable medium as defined in claim 63 having instructions stored thereon that, when executed, cause the machine to detect at least one of a blank frame, a scene change event, and an audio event associated with the media composition.

69. A computer readable medium as defined in claim 68 having instructions stored thereon that, when executed, cause the machine to determine temporal information and spatial information associated with the at least one of a blank frame, a scene change event, and an audio event.

70. A computer readable medium as defined in claim 63 having instructions stored thereon that, when executed, cause the machine to insert at least a portion of the trigger compilation into at least one vertical blanking interval of the media composition.

71. A computer readable medium as defined in claim 63 having instructions stored thereon that, when executed, cause the machine to insert at least a portion of the trigger compilation into at least one data field associated with the inband survey.

72. A method comprising:
identifying metadata associated with a media composition; and
generating a trigger file based on the metadata and survey information.

73. A method as defined in claim 72, wherein identifying the metadata comprises at least one of generating the media composition metadata based on the media composition and extracting the metadata from the media composition.

74. A method as defined in claim 72, further comprising storing the trigger file separately from the media composition.

75. A method as defined in claim 72, further comprising inserting at least one watermark into the media composition.

76. A method as defined in claim 75, wherein inserting the at least one watermark into the media composition comprises inserting location information into the media composition associated with the location of at least one of the trigger file and the survey information.

77. A method as defined in claim 72, wherein generating the trigger file comprises detecting at least one of a blank frame, a scene change event, and an audio event associated with the media composition.

78. A method as defined in claim 77, wherein detecting the at least one of a blank frame, a scene change event, and an audio event comprises determining temporal information and spatial information associated with the at least one of a blank frame, a scene change event, and an audio event.

79. An apparatus comprising:
a processor system including a memory;
instructions stored in the memory that enable the processor system to:
identify metadata associated with a media composition; and
generate a trigger file based on the metadata and survey information.

80. An apparatus as defined in claim 79, wherein the instructions stored in the memory enable the processor system to identify the metadata based on at least one of generating the metadata based on the media composition and extracting the metadata from the media composition.

81. An apparatus as defined in claim 79, wherein the instructions stored in the memory enable the processor system to store the trigger file separately from the media composition.

82. An apparatus as defined in claim 79, wherein the instructions stored in the memory enable the processor system to insert at least one watermark into the media composition.

83. An apparatus as defined in claim 82, wherein the at least one watermark includes location information associated with the location of at least one of the trigger file and the survey information.

84. An apparatus as defined in claim 79, wherein the instructions stored in the memory enable the processor system to detect at least one of a blank frame, a scene change event, and an audio event associated with the media composition.

85. An apparatus as defined in claim 84, wherein the instructions stored in the memory enable the processor system to determine temporal information and spatial information associated with the at least one of a blank frame, a scene change event, and an audio event.

86. A computer readable medium having instructions stored thereon that, when executed, cause a machine to:
identify metadata associated with a media composition; and
generate a trigger file based on the metadata and survey information.

87. A computer readable medium as defined in claim 86 having instructions stored thereon that, when executed, cause a machine to identify the metadata based on at least one of generating the metadata based on the media composition and extracting the metadata from the media composition.

88. A computer readable medium as defined in claim 86 having instructions stored thereon that, when executed, cause the machine to store the trigger file separately from the media composition.

89. A computer readable medium as defined in claim 86 having instructions stored thereon that, when executed, cause the machine to insert at least one watermark into the media composition.

90. A computer readable medium as defined in claim 86 having instructions stored thereon that, when executed, cause the machine to insert location information into the media composition associated with the location of at least one of the trigger file and the survey information.

91. A computer readable medium as defined in claim 86 having instructions stored thereon that, when executed, cause the machine to detect at least one of a blank frame, a scene change event, and an audio event associated with the media composition.

92. A computer readable medium as defined in claim 91 having instructions stored thereon that, when executed, cause the machine to determine temporal information and spatial information associated with the at least one of a blank frame, a scene change event, and an audio event.

93. A method comprising:
extracting a trigger compilation and survey information from an inband survey;
extracting trigger information from the trigger compilation; and
presenting the survey information based on the trigger information.

94. A method as defined in claim 93, further comprising extracting a media composition from the inband survey.

95. A method as defined in claim 94, further comprising decoding at least one of video media, audio media, graphics media, textual media, and still picture media from the media composition.

96. A method as defined in claim 94, wherein extracting the survey information comprises extracting survey questions associated with the media composition.

97. A method as defined in claim 94, wherein presenting the survey information comprises synchronizing the survey information with a presentation of the media composition based on the trigger information.

98. A method as defined in claim 97, further comprising pausing the presentation of the media composition based on the trigger information.

99. A method as defined in claim 93, wherein extracting the trigger information comprises extracting temporal information and spatial information associated with the survey information.

100. An apparatus comprising:
a processor system including a memory;
instructions stored in the memory that enable the processor system to:
extract a trigger compilation and survey information from an inband survey;
extract trigger information from the trigger compilation; and
present the survey information based on the trigger information.

101. An apparatus as defined in claim 100, wherein the instructions stored in the memory enable the processor system to extract a media composition from the inband survey.

102. An apparatus as defined in claim 101, wherein the instructions stored in the memory enable the processor system to decode at least one of video media, audio media, graphics media, textual media, and still picture media from the media composition.

103. An apparatus as defined in claim 101, wherein the instructions stored in the memory enable the processor system to extract metadata from the inband survey associated with the media composition.

104. An apparatus as defined in claim 101, wherein the survey information includes survey questions associated with the media composition.

105. An apparatus as defined in claim 101, wherein the instructions stored in the memory enable the processor system to synchronize the survey information with a presentation of the media composition based on the trigger information.

106. An apparatus as defined in claim 105, wherein the instructions stored in the memory enable the processor system to pause the presentation of the media composition based on the trigger information.

107. An apparatus as defined in claim 100, wherein the instructions stored in the memory enable the processor system to extract temporal information and spatial information associated with the survey information.

108. A computer readable medium having instructions stored thereon that, when executed, cause a machine to:
extract a trigger compilation and survey information from an inband survey;
extract trigger information from the trigger compilation; and
present the survey information based on the trigger information.

109. A computer readable medium as defined in claim 108 having instructions stored thereon that, when executed, cause the machine to extract a media composition from the inband survey.

110. A computer readable medium as defined in claim 109 having instructions stored thereon that, when executed, cause the machine to decode at least one of video media, audio media, graphics media, textual media, and still picture media from the media composition.

111. A computer readable medium as defined in claim 109 having instructions stored thereon that, when executed, cause the machine to extract survey questions associated with the media composition from the survey information.

112. A computer readable medium as defined in claim 109, having instructions stored thereon that, when executed, cause the machine to extract metadata associated with the media composition from the inband survey.

113. A computer readable medium as defined in claim 109 having instructions stored thereon that, when executed, cause the machine to synchronize the survey information with a presentation of the media composition based on the trigger information.

114. A computer readable medium as defined in claim 113 having instructions stored thereon that, when executed, cause the machine to pause the presentation of the media composition based on the trigger information.

115. A computer readable medium as defined in claim 108 having instructions stored thereon that, when executed, cause the machine to extract temporal information and spatial information associated with the survey information.

116. A method comprising:
presenting at least a portion of a media composition;
extracting trigger information associated with the media composition from a trigger file; and
presenting survey information associated with the media composition based on the trigger information.

117. A method as defined in claim 116, wherein presenting the at least a portion of a media composition comprises presenting at least one of video media, audio media, graphics media, textual media, and still picture media from the media composition.

118. A method as defined in claim 116, further comprising retrieving the media composition, the trigger file, and the survey information independent from one another.

119. A method as defined in claim 116, wherein presenting the survey information comprises presenting survey questions associated with the media composition.

120. A method as defined in claim 116, wherein presenting the survey information comprises synchronizing a presentation of the survey information with a presentation of the media composition based on the trigger information.

121. A method as defined in claim 116, further comprising pausing the presentation of the media composition based on the trigger information.

122. A method as defined in claim 116, wherein extracting the trigger information comprises extracting temporal information and spatial information associated with the survey information.

123. An apparatus comprising:
a processor system including a memory;
instructions stored in the memory that enable the processor system to:
present at least a portion of a media composition;
extract trigger information associated with the media composition from a trigger file; and
present survey information associated with the media composition based on the trigger information.

124. An apparatus as defined in claim 123, wherein the at least a portion of a media composition comprises at least one of video media, audio media, graphics media, textual media, and still picture media.

125. An apparatus as defined in claim 123, wherein the instructions stored in the memory enable the processor system to retrieve the media composition, the trigger file, and the survey information independent from one another.

126. An apparatus as defined in claim 123, wherein the survey information includes survey questions associated with the media composition.

127. An apparatus as defined in claim 123, wherein the instructions stored in the memory enable the processor system to synchronize a presentation of the survey information with a presentation of the media composition based on the trigger information.

128. An apparatus as defined in claim 123, wherein the instructions stored in the memory enable the processor system to pause the presentation of the media composition based on the trigger information.

129. An apparatus as defined in claim 123 wherein the instructions stored in the memory enable the processor system to extract temporal information and spatial information associated with the survey information.

130. A computer readable medium having instructions stored thereon that, when executed, cause a machine to:
present at least a portion of a media composition;
extract trigger information associated with the media composition from a trigger file; and
present survey information associated with the media composition based on the trigger information.

131. A computer readable medium as defined in claim 130 having instructions stored thereon that, when executed, cause the machine to present at least one of video media, audio media, graphics media, textual media, and still picture media associated with the media composition.

132. A computer readable medium as defined in claim 130 having instructions stored thereon that, when executed, cause the machine to retrieve the media composition, the trigger file, and the survey information independent from one another.

133. A computer readable medium as defined in claim 130 having instructions stored thereon that, when executed, cause the machine to extract survey question associated with the media composition from the survey information.

134. A computer readable medium as defined in claim 130 having instructions stored thereon that, when executed, cause the machine to synchronize a presentation of the survey information with a presentation of the media composition based on the trigger information.

135. A computer readable medium as defined in claim 130 having instructions stored thereon that, when executed, cause the machine to pause the presentation of the media composition based on the trigger information.

136. A computer readable medium as defined in claim 130 having instructions stored thereon that, when executed, cause the machine to extract temporal information and spatial information associated with the survey information.
